(19) United States
(12) Patent Application Publication
(10) Pub. No.: US 2021/0140337 A1
(43) Pub. Date: May 13, 2021

(54) TURBINE AND COMPRESSOR BLADE DEFORMATION AND AXIAL SHIFT MONITORING BY PATTERN DEPLOYMENT AND TRACKING IN BLADE POCKETS

(71) Applicant: Siemens Energy, Inc., Orlando, FL (US)

(72) Inventors: Heiko Claussen, North Brunswick, NY (US); Christine P. Spiegelberg, Winter Park, FL (US); Joshua S. McConkey, Orlando, FL (US)

(21) Appl. No.: 16/629,861

(22) PCT Filed: Aug. 1, 2017
(86) PCT No.: PCT/US2017/044780

§ 371 Date: Jan. 9, 2020

(51) Int. Cl. F01D 21/00; F04D 27/00; F04D 29/32; G01H 1/00

(52) U.S. Cl. CPC F01D 21/003; F04D 27/001; F04D 29/324; F05D 2270/804; F05D 2240/307; F05D 2260/80; G01H 1/006

(57) ABSTRACT

A method of monitoring a rotor blade 14 is provided. The method includes disposing a probe 22 including an optical sensor 25 within a mounting hole in a turbine casing 36 of a turbine engine. A laser beam is them emitted by a light source 54 radially inward from the probe position onto a rotor blade tip 100 of the rotor blade 14. The rotor blade 14 is positioned such that it periodically passes the laser beam. The rotor blade tip 100 includes a predetermined pattern 120. The reflected light images from the rotor blade tip 100 are received by the optical sensor 25. From the reflected light images, a blade profile is constructed. Based on this constructed blade profile from the reflected light images off the predetermined pattern 120, a position of the rotor blade 14 is determined. A system of monitoring a rotor blade 14 is also provided.

### BACKGROUND

### 1. Field

This disclosure relates generally to diagnostic testing and monitoring of rotor blades. In particular, a method of monitoring rotor blades using a predetermined pattern on the blade tip in order to detect blade deformation and axial shift of the rotor blades is presented.

### 2. Description of the Related Art

The compressor and turbine section of a gas turbine is composed of rings with blades that rotate around a joint shaft (rotor). The blades in the compressor reduce the volume of the working gas, thus increasing its pressure and temperature. After the compressor, the combustor section further increases the gas temperature by burning fossil fuels, for example. Thereafter, the blades in the turbine section extract energy from the working gas by translating its expansion to a rotational force on the shaft.

The combination of gas pressure, centrifugal force, pressure fluctuations or resonances, and temperature create significant stress on the blades that may result in blade deformations and breaking. Breaking of a blade may have a catastrophic effect on the gas turbine as the material that breaks off from the blade travels through the turbine causing damage leaving the turbine inoperable. Thus, it is imperative to monitor the stress on the blades during operation so that any deficiencies found may be fixed before catastrophic damage occurs.

### SUMMARY

Briefly described, aspects of the present disclosure relates to a method and system for monitoring a rotor blade.

A method of monitoring a rotor blade is provided. The method includes disposing a probe including an optical sensor within a mounting hole in a turbine casing of a turbine engine. A laser beam is them emitted by a light source radially inward from the probe position onto a rotor blade tip of the rotor blade. The rotor blade is positioned such that it periodically passes the laser beam. The rotor blade tip includes a predetermined pattern. The reflected light images from the rotor blade tip are received by the optical sensor. From the reflected light images, a blade profile is constructed. Based on this constructed blade profile from the reflected light images off the predetermined pattern, a position of the rotor blade is determined.

A rotor blade monitoring system is also provided. The system includes a rotating rotor blade having a rotor blade tip including a predetermined pattern, a light source that emits a laser beam radially inward onto the rotating rotor blade tip, a probe including an optical sensor disposed within a mounting hole of a turbine casing of a turbine engine, and a processor coupled to the optical sensor for constructing a blade profile from the reflected light images off the predetermined pattern. The optical sensor is configured to receive the reflected light images. From the constructed blade profile, the position of the rotor blade is determined.

### BRIEF DESCRIPTION OF THE DRAWINGS

FIG. 1 illustrates a diagrammatic view illustrating a turbine and a blade monitoring system,

FIG. 2 illustrates a top view of a rotor blade including a deployed pattern in the pocket of the rotor blade tip,

FIG. 3 illustrates an embodiment of a predetermined pattern, and

FIG. 4 illustrates a flowchart of the proposed method.

### DETAILED DESCRIPTION

To facilitate an understanding of embodiments, principles, and features of the present disclosure, they are explained hereinafter with reference to implementation in illustrative embodiments. Embodiments of the present disclosure, however, are not limited to use in the described systems or methods.

The components and materials described hereinafter as making up the various embodiments are intended to be illustrative and not restrictive. Many suitable components and materials that would perform the same or a similar function as the materials described herein are intended to be embraced within the scope of embodiments of the present disclosure.

Commonly, the stress on the blades is monitored by an optical tip timing system that measures the arrival times of each blade using a laser. A challenge with this approach is that the profile of the blade is very different depending on the position where the laser hits the blade. This position cannot be well controlled due to the thermal expansion of the shaft.

Similarly, vibrations of the blades are monitored using blade tip timing systems. The arrival times of the blades are measured through different physical effects including, for example, changes in capacitive field or optical reflections of a laser beam. The sequence of arrival times may be evaluated for each blade to resolve vibrations and frequencies of vibration. An advantage of using the capacitive method is the low cost of each sensor while disadvantages include sensitivity to the blade tip distance and the presence of noise in the signal, such that the signal is not smooth, resulting in a high uncertainty on the tip timing measurement.

There are multiple optical approaches that address various challenges. They generally function by emitting a laser beam through the casing of the turbine onto the blade ring. When a blade passes by the laser beam, the reflected light is measured and analyzed. An advantage of this approach is a sharp rise when a blade flank passes in front of the laser which translates to highly accurate tip timing measurements. However, this approach is sensitive to axial shift and blade bending as the blade profile varies for different axial positions and angles. Axial shift, or axial movement of the blade relative to the rotation axis of the blade, may occur during operation of the turbine engine. Axial movements of the blades during operation may occur as the rotor spins up or down, as the turbine warms up and cools down, as the load on the turbine changes, and due to torsional movements of the blades. Blade bending occurs when the blade deforms somewhat, twists, tilts or moves in a direction towards the casing.

In order to compensate for the uncertainty in the axial shift, multiple rows of blades may be monitored and a common shift in arrival time may be extracted and related to the rotor movement. In general, it is very difficult to accommodate for blade bending and determine the actual position of the measurement spot of the blade profile. Several laser beams may be used, for example, four for each blade ring. The tip arrival information from the different laser measurements may be used to reconstruct the blade profile. The reconstructed blade profile can then be used to compensate for the axial shift. These approaches, however, are significantly more expensive as they requires multiple sensor installations and high frequency data acquisition channels per blade ring and are also computationally challenging. There remains a significant uncertainty given the many possible bending modes of the blades as well as different blade distances to the casing.

Consequently, a method of monitoring rotating blades having better measurement accuracy of the blade deformation and axial shift using an optical tip timing system with an optical sensor is desired.

The inventors propose extending the capability of an optical tip timing system with at least one sensor per row of blades to better measure blade bending, blade vibrations, and axial shift. Currently, tip timing systems only measure the simple shape of the blade profile with uncertainty on the exact location where the laser crosses over the profile. This location is dependent on different bending modes of the blade and axial shift resulting from the thermal expansion of the turbine shaft. Due to the simple shape profile of the blade, it is not possible to extract all blade bending modes and axial shift from a single path laser measurement.

FIG. 1 diagrammatically illustrates a turbine 8 including an unshrouded blade row 10 in which the proposed method and blade monitoring system may be employed to monitor the condition of rotating blades 14. Unshrouded blades are illustrated; however, one skilled in the art would recognize that the proposed method and blade vibration monitor would also benefit a shrouded design of blades. The rotating blades 14 are connected to a rotor 16 by means of a rotor disk 18 and form a blade structure 15 within the turbine 8.

A rotating blade monitoring system 20 is also shown in FIG. 1. The system 20 includes a rotor blade probe 22 mounted to a casing 36 of the turbine 8 for monitoring the rotor blades 14. It should be understood that although only one probe 22 is described herein with reference to the present invention, a plurality of probes 22 may be provided. In some embodiments, at least two probes, a primary probe and a backup probe, may be provided adjacent to one another for redundancy. In other embodiments, using other known analysis techniques, the probes 22 may be positioned in a specified unequally spaced pattern.

In an embodiment, the probe 22 includes an optical sensor 25 which may produce a signal in response to a passing rotor blade 14. The optical sensor 25 may include a fiber optic portion that detects blade passing events during blade vibration monitoring. In this embodiment, a light source 54 emits a laser beam through the turbine casing 36. The fiber optic portion may include an illumination conduit having a transmission end for projecting the light source onto the rotor blade tip and a receptor end for receiving the reflected light images from the rotor blade tip.

As is further illustrated in FIG. 1, a reference sensor 24 is additionally provided. The reference sensor 24, in conjunction with an indicia 21 on the rotor 16, is operable to provide a once-per-revolution (OPR) reference pulse signal. Signals from the probe 22 and the signals from the reference sensor 24 are provided as inputs to a blade monitoring processor 28. The output of the blade monitoring processor 28 may be input to a signal analyzer 32 to perform signal conditioning and analysis.

In accordance with an embodiment, a rotor blade monitoring system 20 includes a rotor blade 14 having a rotor blade tip including a predetermined pattern. A top view of a rotor blade tip 100 is illustrated in FIG. 2. The rotor blade tip 100 includes a predetermined pattern 120. The predetermined pattern 120 may be disposed in a pocket 110 of the rotor blade tip 100. The pocket 110 may be located between the edges 130 of the blade 14 in which the surface of the pocket 110 may be slightly recessed from the edges 130 of the rotor blade 14. This location in the pocket 110 of the rotor blade tip 100 may protect the predetermined pattern 120 from dirt, strain, and/or temperature exposure while allowing an optimal position for the readout with the laser. Additionally, FIG. 2 illustrates a laser path 200 emitted by a light source 54 onto the rotor blade tip 100.

The predetermined pattern 120 may be created on the rotor blade 14 by laser cutting small structures into the rotor blade tip 100. In another embodiment, the predetermined pattern 120 may comprise reflective paint applied onto the surface of the rotor blade tip 100. In a further embodiment, materials with different reflection coefficients may be inlaid onto the surface of the rotor blade tip 100. In a further embodiment, the pattern may be created by additive manufacturing. Additionally, the predetermined pattern 120 may be created by a combination of the presented embodiments. As the rotor blade tip 100 is exposed to extremely high temperatures, the predetermined pattern 120 should be robust enough to withstand these extreme temperatures.

An effective pattern may include a simple pattern that accurately differentiates different angles and translations of the laser path over the pattern 120. A simple design may be advantageous as a more complex pattern with fine structures could be harder to reliably read or be more easily damaged by exposure to dirt. A more complex pattern may require more accurate control with the laser source, a smaller laser focus, and higher sampling frequencies. Therefore, a good pattern may include a non-symmetric, non-periodic pattern such that the message of the pattern is changed based on the position and angle. Additionally, a continuous pattern is preferable over a digital pattern often used in two-dimensional bar codes. This allows a distinctive pattern readout variation based on a continuous change in position or angle. Otherwise, the laser could read out points in between digital zero and one values resulting in an unclear message. Information may be encoded in a predetermined pattern 120 so that the position of the rotor blade 14 may be accurately determined.

In an embodiment, several distinct patterns may be used successively on the rotor blade tip to diagnose different blade issues. For example, with one specific pattern it may be easier to diagnose axial shift as opposed to blade bending of the rotor blade 14. Additionally, these distinct patterns may be created by different processes.

In an embodiment, the predetermined pattern may 120 include a two dimensional pattern. An example of a two dimensional pattern may be seen in FIG. 3. The predetermined pattern 120 shown in FIG. 3 includes a non-symmetric pattern that results in different reflections for translations for different approach angles of the laser beam.

In another embodiment, the predetermined pattern 120 may include a three dimensional pattern. The three dimensional pattern may include structures with varying heights on the surface of the rotor blade tip 100. A three dimensional pattern in a pocket 110 of the rotor blade tip 100, for example, could be created by an additive manufacturing process when the rotor blade 14 is manufactured.

To maximize the accuracy of the laser readout, a laser with a wavelength that has a large difference in reflectivity when passing over the predetermined pattern 120 may be used. It may also be advantageous to use a focused laser with a very small beam diameter to differentiate fine pattern differences. The range for the beam diameter may be less than or equal to 0.5 cm in diameter. Preferably, the beam diameter is less than 1 mm in diameter. In order to accommodate this range, for example, a single transverse mode laser may be used.

Referring now to FIGS. 1-4, a method of monitoring a rotor blade is presented. FIG. 4 illustrates a flowchart with steps in the method; however, the steps do not necessarily have to be performed in the order shown. The method includes disposing 300 a probe 22 including an optical sensor 25 within a mounting hole in a turbine casing 36 of a turbine engine. As discussed previously, a light source 54 may emit 310 a laser beam radially inward through the turbine casing 36 from the position of the probe 22 onto a rotor blade tip 100. It should be noted that a rotor blade tip 100 comprises the blade surface defined by the radially outer tip of each rotor blade 14. The rotor blade 14 rotates around the joint shaft 16 such that it periodically passes the laser beam. A pulse of light may be produced by the laser light reflected from the tip edge as it passes the probe 22 and is received 320 by the optical sensor 25 disposed within the probe 22. The probe 22 may be coupled to a processor 28 which uses the reflected light images to create 330 a blade profile. From the created blade profile, the position of the rotor blade 14 may be accurately determined 340.

In accordance with an embodiment, the blade tip 100 includes a predetermined pattern 120 as discussed above. The predetermined pattern 120 may be deployed in a recessed pocket 110 of the blade tip 100.

FIG. 3 also illustrates how the method using the predetermined pattern 120 may assist in the accurate determination of blade position, and specifically, to assist in characterizing a blade movement as an axial shift, blade deformation, and/or blade vibration. The lines, 210, 220, and 230 illustrate possible paths and/or reflections of the laser beam depending on the position of the rotor blade 14. Depending on the path 210, 220, and 230 that the laser takes, different encoded information would be read out from the reflected light patterns.

For example, the laser path, shown as a horizontal line 220 through the center of the predetermined pattern 120 in the illustrated embodiment, would be expected when the blade positioning is correct, i.e., with no axial shift, blade bending or vibrations during operation. If the laser path reads out the encoded information in the laser path shown by horizontal line 210, one could infer that an axial shift has occurred as the read out encoded information would differ from the encoded pattern read out when the blade is correctly positioned. Additionally, from the encoded pattern, which would be unique based on the approach angle and the translation of the laser, one could accurately determine the amount of axial shifting, denoted by distance d in FIG. 4, the rotor blade has experienced. The laser may also take a path, for example, exemplified by horizontal line 230. In this example, the approach angle has changed from the horizontal path of line 220. From the encoded information read out, in this example, one may be able to detect that blade bending has occurred. The incident approach angle of the laser beam may be calculated from the encoded information indicating how much the blade has turned, tilted or twisted. Note that the predetermined pattern 120 shown in FIG. 2 may also be used to detect blade bending in the third dimension. In this case, the left side would be lowered and the right side of the pattern would be raised. That is, the distances of the lines on the left side would be reduced while the distances on the right side would be increased.

The method may also be used to characterize the movement of the rotor blade 14 as a blade vibration. As mentioned previously, vibrations of a rotor blade 14 are typically determined using tip timing systems, specifically by marking deviations from a constant time of arrival for each blade. However, using the current methods it is difficult to make an accurate measurement of the time-of-arrival of each rotor blade because of the sensitivity of the sensor to the blade tip distance and noise in the signal. Using the proposed method, deviations of the time of arrival of each blade may be more accurately extracted. The blade monitoring system 20 is configured to record the time of arrival by the sensing the passage of the same pattern of encoded information on multiple passes, where the same pattern of encoded information corresponds to a precise location on the rotor blade 14. From the recording of the time of arrival data, the vibrational movement of the associated blade may be determined.

Using current tip timing systems, typically, either the leading edge or the trailing edge of the rotor blade are used to detect a blade passing event. However, using the proposed system with the predetermined pattern, the tip timing measurement may be refined such that a correlation with a specific encoded message of the predetermined pattern should allow for a more accurate detection of the arrival time than just tracking the two edges of the rotor blade.

Results from this method can be output as a reporting value including an output of the position of the rotor blade 14 which provides an indication of the condition of the blade and operational state. That is, if the rotor blades are vibrating too much, at an undesired eigenfrequency, are bent too much, or approach the outer casing of the turbine, it may be desirable to perform control decisions like unloading. Moreover, a change in operating parameters of the rotor assembly can be implemented based upon this indication of the blade condition and operational state. A variety of operating parameter changes may include, for example, initiating a shutdown, changing the rotor frequency, and reducing the load.

While embodiments of the present disclosure have been disclosed in exemplary forms, it will be apparent to those skilled in the art that many modifications, additions, and deletions can be made therein without departing from the spirit and scope of the invention and its equivalents, as set forth in the following claims.

What is claimed is:

1. A method of monitoring a rotor blade 14, comprising
disposing a probe 22 including an optical sensor 25 within a mounting hole in a turbine casing 36 of a turbine engine;
emitting a laser beam by a light source 54 radially inward from the probe 22 position onto a rotor blade tip 100 of the rotor blade 14,
wherein the rotor blade 14 periodically passes the laser beam, and
wherein the rotor blade tip 100 includes a predetermined pattern 120;
receiving by the optical sensor 25 reflected light images from the rotor blade tip 100; and
constructing a blade profile from the reflected light images,
determining the position of the rotor blade 14 based on the blade profile constructed from the reflected light images off the predetermined pattern 120.

2. The method as claimed in claim 1, wherein the predetermined pattern 120 is deployed in a pocket 110 disposed in the rotor blade tip 100.

3. The method as claimed in claim 1, wherein the predetermined pattern 120 is created by a process selected from the group consisting of laser cutting small structures into rotor blade tip 100, applying a reflective paint in a pattern onto the surface of the rotor blade tip 100, and inlaying materials with different reflection coefficients on the rotor blade tip 100.

4. The method as claimed in claim 1, wherein the predetermined pattern 120 includes a non-symmetric two dimensional pattern.

5. The method as claimed in claim 1, wherein the predetermined pattern 120 includes a non-symmetric three dimensional pattern.

6. The method as claimed in claim 1, further comprising changing a physical operating parameter of the turbine engine in response to the determined position of the rotor blade 14.

7. The method as claimed in claim 6, wherein the physical operating parameter of the turbine engine comprises at least one of the group consisting of initiating a shutdown, changing a load, and changing a rotor frequency.

8. The method as claimed in claim 1, wherein the laser includes a beam diameter in a range of ≤0.5 cm.

9. The method as claimed in claim 8, wherein the laser is a single transverse mode laser.

10. The method as claimed in claim 1, wherein the determining includes characterizing a movement of the rotor blade 14.

11. The method as claimed in claim 10, wherein the movement of the rotor blade 14 is characterized as an axial shift.

12. The method as claimed in claim 11, including determining an amount of axial shift.

13. The method as claimed in claim 10, wherein the movement of the rotor blade 14 is characterized as a blade bending.

14. The method as claimed in claim 13, including correlating the approach angle of laser beam calculated from the reflected light images to an amount of movement of the rotor blade 14.

15. The method as claimed in claim 10, wherein the movement of the rotor blade 14 is characterized as a blade vibration.

16. The method as claimed in claim 15, including recording a time of arrival for each pass of a rotor blade tip portion, and using the time of arrival for multiple passes of the rotor blade tip portion to determine vibrational movement of the associated blade.

17. The method as claimed in claim 1, including recording a time of arrival by the sensing the passage of the same pattern of encoded information on multiple passes to enable a tip timing measurement, where the same pattern of encoded information corresponds to a precise location on the rotor blade.

18. A rotor blade monitoring system, comprising:
a rotating rotor blade 14 having a rotor blade tip 100 including a predetermined pattern 120;
a light source 54 emitting a laser beam radially inward onto the rotating rotor blade tip 100;
a probe 22 including an optical sensor 25 disposed within a mounting hole of a turbine casing 36 of a turbine engine, the optical sensor 25 configured to receive reflected light images, and
a processor 28 coupled to the optical sensor 25 for constructing a blade profile from the reflected light images off the predetermined pattern 120,
wherein from the constructed blade profile, the position of the rotor blade 14 is determined.

19. The monitoring system as claimed in claim 18, wherein the predetermined pattern 120 is deployed in a pocket 110 disposed in the rotor blade tip 100.

20. The monitoring system as claimed in claim 18, wherein the predetermined pattern 120 includes a two-dimensional non-symmetric pattern.
